(19) United States
(12) Patent Application Publication
(10) Pub. No.: US 2009/0266921 A1
(43) Pub. Date: Oct. 29, 2009

(54) FUEL INJECTOR WITH DIRECTLY TRIGGERED INJECTION VALVE MEMBER

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/721,982

(22) PCT Filed: Nov. 24, 2005
(86) PCT No.: PCT/EP2005/056185

§ 371 Date: Jun. 18, 2007

(30) Foreign Application Priority Data
Dec. 23, 2004 (DE) 102004062006.7

(51) Int. Cl. F02M 51/00

(52) U.S. Cl. 239/585.5

(57) ABSTRACT

A fuel injector having an injector body and a fuel inlet communicates with a high-pressure fuel source outside the injector body and including an actuator received in a hollow chamber from which a high-pressure inlet extends to an injection valve member. Depending on the pressure in the first hydraulic chamber, fuel is injected into a combustion chamber of an internal combustion engine when the injection valve member lifts from a seat. The actuator acts directly upon a stepped piston which defines the first hydraulic chamber and actuates a control piston. The injection valve member is guided in the control piston.

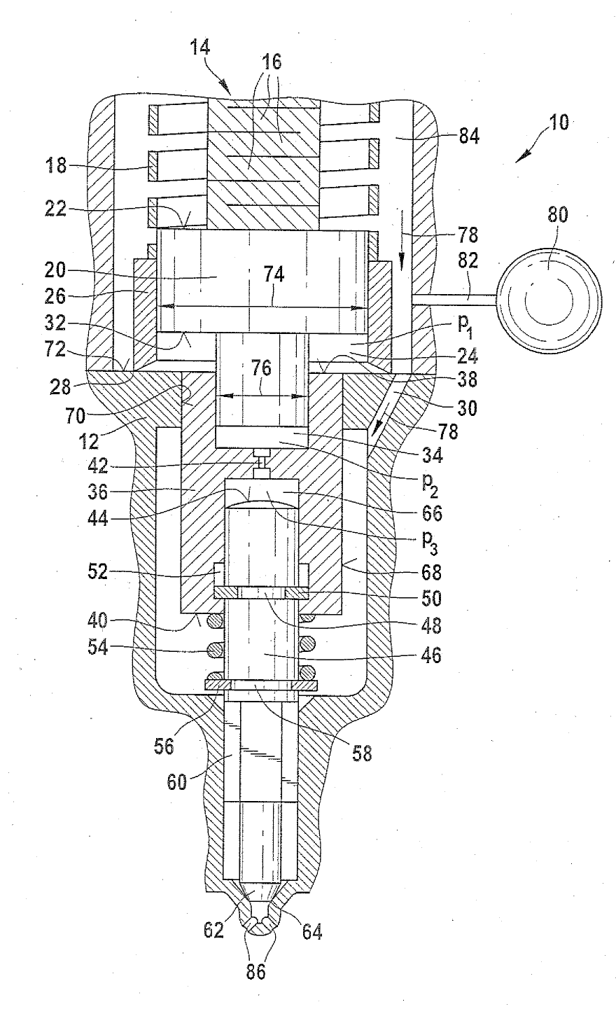

### FIELD OF THE INVENTION

In internal combustion engines, fuel injectors are used, with which fuel that is at high pressure is injected into the combustion chambers of the engine. Such fuel injectors, which are used for instance in self-igniting internal combustion engines, include an injector housing, which is in communication with a high-pressure source located outside the fuel injector, such as a high-pressure collection chamber (common rail). The high-pressure collection chamber is supplied in turn with fuel that is at high pressure via a high-pressure pump.

### PRIOR ART

German Patent Disclosure 10 2004 037 125.3 relates to a common rail injector. This injector includes an injector housing with a fuel inlet, which is in communication with a central high-pressure fuel source outside the injector housing and with a pressure chamber inside the injector housing. From the latter, as a function of the pressure in a nozzle needle control chamber, fuel subjected to high pressure is injected into a combustion chamber of an internal combustion engine when a nozzle needle lifts from its seat. The nozzle needle control chamber is in communication with an actuator pressure chamber that is defined by an actuator, which is preferably a piezoelectric actuator. Between the actuator pressure chamber and the nozzle needle control chamber, a throttle device is disposed, which upon evacuation of the nozzle needle control chamber makes a smaller flow rate from the nozzle needle control chamber into the actuator pressure chamber possible than upon filling of the nozzle needle control chamber from the actuator pressure chamber into the nozzle needle control chamber. The throttle device is designed and disposed such that it develops its throttling action only upon evacuation of the nozzle needle control chamber, while upon filling of the nozzle needle control chamber it does not develop any throttling action but instead assures an unhindered flow through of fuel. The throttle device includes a throttle piston, which has a through hole that makes a throttled flow through of fuel from the nozzle needle control chamber into the actuator pressure chamber possible.

In fuel injectors in which the pressure in a control chamber is controlled by an actuator, such as a piezoelectric actuator, the term used is also direct control, or in other words a direct control of the injection valve member, which for example may be embodied as a nozzle needle.

### SUMMARY OF THE INVENTION

The fuel injector proposed in accordance with the invention is distinguished by a very simple, compact construction. In particular, by the use of a piston that can be embodied in steplike form associated with an actuator, the opening of the injection valve member that can be embodied as a nozzle needle is achieved in a very simple way.

The actuator, in particular a piezoelectric actuator, is received in a hollow chamber, into which a line from a high-pressure collection chamber (common rail) discharges. The piston that can be embodied in steplike form that can be acted upon directly by the actuator is on the one band surrounded by a sleeve defining a first hydraulic chamber; on the other hand, part of the piston that can be embodied in steplike form is guided in a control piston. The piston that can be embodied in steplike form, with an annular face at the transition in diameter, defines a first hydraulic chamber, and with an end face embodied with a lesser diameter, it defines a second hydraulic chamber inside the control piston. Inside the control piston, a further, third hydraulic chamber is embodied; the second and third hydraulic chambers communicate hydraulically via a conduit that contains a throttle restriction. Also located in the control piston is a recess, in which a driver, which is received on the circumference of the injection valve member that can be embodied as a nozzle needle, is movable. Via a compression spring, braced on the lower face end of the control piston, the injection valve member that can be embodied as a nozzle needle is placed relative to the control piston such that the mechanical driver, which can be embodied for instance as a disk or ring, always rests on a stop of the recess inside the control piston. The actuator which is received in the hollow chamber of the fuel injector is triggered inversely. Upon an inverse triggering of a piezoelectric actuator, current is supplied to the piezoelectric actuator, and the injection valve member that can be embodied as a nozzle needle is in its closed state. The injection openings embodied on the combustion chamber end of the fuel injector are closed by the injection valve member that can be embodied as a nozzle needle and is placed in its seat. For opening of the injection valve member, the piezoelectric actuator is switched to a currentless state, so that the length of the piezoelectric crystal stack of the piezoelectric actuator is reduced. This leads to a pressure relief of the first hydraulic chamber, which in turn leads to the opening of the injection valve member.

Upon pressure relief of the first hydraulic chamber, the control piston moves into this hydraulic chamber. Simultaneously, by means of the piston that can be embodied in steplike form, the second hydraulic chamber inside the control piston is relieved, which thus reinforces the opening of the injection valve member that can be embodied as a nozzle needle. Upon pressure relief of the second hydraulic chamber, the third hydraulic chamber is also pressure-relieved, since it communicates with the second hydraulic chamber with a conduit. The control piston communicates via the mechanical driver with the injection valve member that can be embodied as a nozzle needle, so that upon pressure relief of the first hydraulic chamber by upward motion of the piston that can be embodied in steplike form as the control piston is moving into the first hydraulic chamber, the injection valve member that can be embodied as a nozzle needle is pulled upward. The opening of the nozzle needle is thus based on two effects, namely the pressure relief of the first hydraulic chamber upon upward motion of the piston that can be embodied in steplike form, and the associated pulling upward of the injection valve member that can be embodied as a nozzle needle by the mechanical driver and by the pressure relief of the two hydraulic chambers embodied in the control piston. Because of the pressure reduction in the two hydraulic chambers embodied in the control piston, or in other words in the second and third hydraulic chambers, a delayed pressure reduction takes place, so that the injection valve member that can be embodied as a nozzle needle lifts from the mechanical driver and automatically opens wider, without requiring that the piezoelectric actuator be moved farther.

The way proposed by the invention of attaining the above object is distinguished by its simple construction and by the fact that the piston that can be embodied in steplike form not only actuates the control piston into which the injection valve member that can be embodied as a nozzle needle is guided but also assures a pressure reduction or pressure increase in the two communicating second and third hydraulic chambers. Since the second hydraulic chamber and the third hydraulic chamber are coupled together via a conduit that contains a throttle restriction, the pressure reduction in the third hydraulic chamber takes place in delayed fashion, compared with the pressure reduction in the second hydraulic chamber, so that the possibility exists that the injection valve member that can be embodied as a nozzle needle is capable of moving relative to the control piston and in particular automatically opens wider upon the opening event without requiring that the actuator, which can be embodied as a piezoelectric actuator, be moved farther.

### DRAWING

The invention will be described in further detail below in conjunction with the drawing.

The sole FIGURE shows a cross section through the fuel injector proposed according to the invention.

### VARIANT EMBODIMENTS

A fuel injector 10 includes an injector body 12, in which a hollow chamber 84 is embodied. Discharging into the hollow chamber 84 is a line 82, which extends between the injector body 12 of the fuel injector 10 and a high-pressure collection chamber 80 (common rail). Instead of the high-pressure collection chamber 80 (common rail), a different high-pressure source could be used in order to supply the hollow chamber 84 of the fuel injector 10 with fuel that is at high pressure. An actuator 14 is received inside the hollow chamber 84, in the upper region of the fuel injector 10. The actuator 14 is preferably a piezoelectric actuator, which includes a number of piezoelectric crystals which are disposed in stacked fashion one above the other. Via an electrical connection not shown in the drawing, the actuator 14 is connected to a voltage source. Upon subjection of the actuator 14 to a voltage, the individual piezoelectric crystals of a piezoelectric crystal stack lengthen; upon termination of the application of a voltage to the piezoelectric crystal stack of the actuator 14, the piezoelectric crystal stack resumes its original length. The piezoelectric crystal stack 16 of the actuator 14 is surrounded by a spring 18 embodied as an annular spring. Both the spring 18 and the piezoelectric crystal stack 16 rest on an end face 22 of a piston 20 that can be embodied in steplike form.

The piston 20 that can be embodied in steplike form likewise received in the hollow chamber 84 is surrounded by a control chamber sleeve 26. On the control chamber sleeve 26 there is a bite edge 28, with which the control chamber sleeve 26, acted upon by a spring, is positioned on a plane face 72 of the injector body 12. The piston 20 that can be embodied in steplike form includes a first region, which is embodied with a first diameter 74, and a second region, which is embodied with a second diameter 76. The first diameter 74 is dimensioned as larger than the second diameter 76. Because of the diameter difference with which the two portions of the piston 20 that can be embodied in steplike form are dimensioned, a first hydraulic chamber 24 is formed inside the control chamber sleeve 26 that surrounds the piston 20 that can be embodied in steplike form. By means of this chamber, a first face end 38 of a control piston 36 can be acted upon.

On the piston 20 that can be embodied in steplike form, because of the difference in diameter between the first diameter 74 and the second diameter 76, an annular face identified by reference numeral 32 develops, which defines the first hydraulic chamber 24 that is furthermore defined by the inner circumferential surface of the control chamber sleeve 26, by a first face end 38 of the control piston 36, and by parts of the plane face 72 of the injector body 12.

The region of the piston 20 that can be embodied in steplike form embodied with the second diameter 76 acts upon a second hydraulic chamber 34, which is embodied in the control piston 36. The second hydraulic chamber 34 communicates hydraulically with a third hydraulic chamber 66 inside the control piston 36 via a conduit containing a throttle restriction 42.

An end face 44 of an injection valve member 46 that can preferably be embodied as a nozzle needle protrudes into the third hydraulic chamber 66. The injection valve member 46 embodied as a nozzle needle is guided in the control piston 36. In the control piston 36, a hollow chamber 52 is embodied, inside which a mechanical driver 50 is capable of moving. The mechanical driver 50 may for example be embodied as a ring or as a disk, which is received in an annular groove 48 on the circumference of the injection valve member 46 that can be embodied as a nozzle needle.

In the view shown in the drawing, the mechanical driver 50 rests on a stop that defines the hollow chamber 52. In this position, the mechanical driver 50 is retained as a result of the fact that on a second face end 40 of the control piston 36, a spring 54 is received which is braced on a support disk 56, provided in a groove 58, on the outer circumference of the injection valve member 46 that can be embodied as a nozzle needle and positions the injection valve member 46 that can be embodied as a nozzle needle relative to the control piston 36. For the sake of completeness, it will be noted that a first face end 38 of the control piston 36 can be acted upon by the first hydraulic chamber 24.

The control piston 36 is received in a further hollow chamber in the interior of the injector body 12, into which chamber fuel enters from the hollow chamber 84 via a high-pressure inlet 30. The pressure level inside the hollow chamber 84, the first hydraulic chamber 24, and the hollow chamber surrounding the control piston 36 is designated p₁. The respective pressure prevailing in the second hydraulic chamber 36 is designated p₂, while the pressure prevailing in the third hydraulic chamber 66 is designated p₃.

Below the support disk 56 on the outside circumference of the injection valve member 46 that can be embodied as a nozzle needle, there are flat faces 60 by way of which the fuel contained in the hollow chamber that surrounds the control piston 36 flows to a nozzle tip 62 and, via injection openings not shown in the drawing, can be injected into the combustion chamber of an internal combustion engine, if the injection openings are opened by the nozzle tip 62 of the injection valve member 46 that can be embodied as a nozzle needle. In the view shown in the drawing, the nozzle tip 62 is located in a nozzle seat 64, so that the injection of fuel into the combustion chamber of the engine is prevented.

The control piston 36 has a jacket face 68 surrounded by fuel and is guided in a guide 70 that is embodied in the injector body 12. Reference numeral 78 represents the fuel flow which develops from the hollow chamber 84, in which the actuator 14 is received, via the high-pressure inlet 30 into the hollow chamber in which the control piston 36 is movably guided.

The mode of operation of the fuel injector proposed according to the invention is as follows:

Upon inverse triggering of the actuator 14, the injection valve member 46 is in its closing position when the actuator 14 is supplied with current.

In the view shown in the drawing, the injection valve member 46 that can preferably be embodied as a nozzle needle is in its closing position. In this state, the injection openings, not shown in the drawing, into the combustion chamber of an internal combustion engine are closed; the nozzle tip 62 is located in the nozzle seat 64. To effect the closure of the injection valve member 46, the actuator 14, preferably embodied as a piezoelectric actuator, is connected to a voltage source, so that the piezoelectric crystal stack 16 lengthens in accordance with the number of piezoelectric crystals present in it, and the piston 20 that can be embodied in steplike form is subjected to pressure. As a result, the fuel volume present in the first hydraulic chamber 24 is compressed, and the first face end 38 of the control piston 36 is acted upon. Moreover, because of the compression of the fuel volume in the second hydraulic chamber 34, the pressure in the third hydraulic chamber 66 also increases, so that the control piston 36 and the injection valve member 46 guided in it are placed in the nozzle seat 64. No fuel injection occurs.

The opening of the injection valve member 46 that can be preferably embodied as a nozzle needle is effected by canceling the subjection of the actuator 14 to voltage. The individual piezoelectric crystals inside the piezoelectric crystal stack 16 resume their original shape upon cancellation of the subjection of the actuator 14 to voltage; that is, the piston 20 that can be embodied in steplike form moves upward, thus causing a pressure relief of the first hydraulic chamber 24. Because of the pressure relief of the first hydraulic chamber 24, the control piston 36 moves with its first face end 38 into the first hydraulic chamber 24. During the vertical motion of the control piston 36 toward the first hydraulic chamber 24, the mechanical driver 50, received on the circumference of the injection valve member 46, rests on the lower stop of the hollow chamber 52. If the control piston 36 is moving in the vertical direction upward, the injection valve member 46 that can be embodied as a nozzle needle is pulled upward by the mechanical driver 50 surrounded by the control piston 36, and the nozzle tip 62 of the injection valve member 46 that can be embodied as a nozzle needle is moved out of its nozzle seat 64, so that the injection openings on the combustion chamber end of the fuel injector 10—which are not shown in the drawing—are opened, and an injection of fuel into the combustion chamber takes place. Upon opening of the nozzle seat 64, or in other words a vertical motion of the injection valve member 46 that can be embodied as a nozzle needle out of the nozzle seat 64 upon an upward motion of the control piston 36, the second hydraulic chamber 34 is furthermore pressure-relieved. This is due to the fact that upon cancellation of the subjection of the actuator 14 to voltage, the region of the piston 20 that can be embodied in steplike form that is embodied with the second diameter 76 moves out of the second hydraulic chamber 34. Since the second hydraulic chamber 34 and the third hydraulic chamber 66 communicate hydraulically with one another via a conduit that contains a throttle restriction 42, a delayed pressure reduction ensues in the third hydraulic chamber 66 upon pressure relief of the second hydraulic chamber 34. The delayed pressure reduction in the third hydraulic chamber 66 realized in this way causes the injection valve member 46, which can preferably be embodied as a nozzle needle, to move relative to the control piston 36. In this case, the mechanical driver 50 lifts from the lower stop of the hollow chamber 52. The length of the relative motion that occurs between the control piston 36 and the injection valve member 46 that can preferably be embodied as a nozzle needle depends on the length of the hollow chamber 52 in the axial direction of the injection valve member 46. Because of the length of the stroke that the mechanical driver 50, locked onto the injection valve member 46, is capable of executing in the hollow chamber 52, a relative motion of the injection valve member 46, which can preferably be embodied as a nozzle needle, relative to the control piston 36 is possible upon opening, and an automatic opening of the injection valve member 46 is attainable without requiring that the actuator 14 be moved farther.

By the dimensioning of the particular throttle restriction 42 that is provided in the conduit between the second and third hydraulic chambers 34, 66, the delay of the pressure reduction in the third hydraulic chamber 66 can be adjusted.

With the embodiment proposed by the invention, it can be attained that upon the opening of the injection valve member 46 that can be embodied as a nozzle needle, the opening is effected on the one hand by the pressure reduction in the first hydraulic chamber 24 and by the movement of the control piston 36 into it; because of the mechanical driver 50, the injection valve member 46 is pulled upward by the control piston 36, and because of the delayed pressure reduction in the third hydraulic chamber 66, the opening behavior of the fuel injector of the injection valve member 46 can be optimally adapted to the load state of the engine. The construction shown in the drawing of the fuel injector 10 is striking in its simplicity, since the injection valve member 46 that can preferably be embodied as a nozzle needle and the piston 20 that can be embodied in steplike form are both guided in one and the same control piston 36. The control piston 36 is in turn centered and guided with its jacket face 68 in the guide 70 of the injector housing 12.

The filling of the first hydraulic chamber 24 inside the fuel injector 10 takes place via gap flows between the control chamber sleeve 26 and the piston 20 that can be embodied in steplike form, since the hollow chamber 84 in which the aforementioned components are received is subjected to fuel that is at high pressure. The control piston 36 is guided by the guide face 70 inside the injector body 12 of the fuel injector 10. With regard to the filling of the second hydraulic chamber 34 and the third hydraulic chamber 66, it must be remembered that their filling is effected via the hollow chamber, embodied in the lower region of the fuel injector 10, to which fuel that is at high pressure flows in the direction of the arrow 78 from the hollow chamber 84. Via the gaps between the injection valve member 46 and the control piston 36 and via the conduit that contains the throttle restriction 42, the hydraulic chambers 34 and 66, respectively, are subjected to fuel.

By means of the spring element 54, which extends between the second face end 40 of the control piston 36 and the support disk 56 of the injection valve member 46, an outset position of the components 36 and 46 that are movable relative to one another is defined. By means of the spring element 54, the mechanical driver 50, mounted on the circumference of the injection valve member 46 that can be embodied as a nozzle needle, is always placed against the lower stop of the hollow chamber 52 inside the control piston 36. Since the hydraulically effective area, in accordance with the second diameter 76 of the piston 20 that can be embodied in steplike form, is less than the hydraulically effective area of the steplike piston 20, or in other words the inner annular face 32 of the piston 20 that can be embodied in steplike form in accordance with the first diameter 74 and the second diameter 76, the control piston 36 initially executes an opening motion and carries the injection valve member 46 along with it via the mechanical driver 50. Upon an ensuing pressure relief of the third hydraulic chamber 66, the mechanical driver 50 lifts from its stop, shown in the drawing, on the lower end of the control piston 36, so that a wider opening of the injection valve member 46 takes place. The injection openings that discharge, below the nozzle seat 64, into a combustion chamber, not shown, of the internal combustion engine are identified by reference numeral 86.

### LIST OF REFERENCE NUMERALS

10 Fuel injector
12 Injector body
14 Actuator (Piezoelectric actuator)
16 Piezoelectric crystal stack
18 Annular spring around actuator 14
20 Piston that can be embodied in steplike form
22 End face
24 First hydraulic chamber (p₁)
26 Control chamber sleeve
28 Bite edge
30 High-pressure inlet
32 Inner annular face of piston 20
34 Second hydraulic chamber (p₂)
36 Control piston
38 First face end of control piston 36
40 Second face end of control piston 36
42 Throttle restriction
44 End face of injection valve member
46 Injection valve member (nozzle needle)
48 Annular groove
50 Mechanical driver
52 Hollow chamber
54 Spring element
56 Support disk
58 Groove for support disk
60 Flat faces
62 Nozzle tip
64 Nozzle seat
66 Third hydraulic chamber (p₃)
68 Jacket face of control piston 36
70 Guide face of injector body 12
72 Plane face of injector body 12
74 First diameter of piston 20 that can be embodied in steplike form
76 Second diameter of piston 20 that can be embodied in steplike form
78 Fuel flow
80 High-pressure collection chamber (common rail)
82 Line
84 Hollow chamber
86 Injection openings

1-12. (canceled)

13. In a fuel injector, having an injector body, having a fuel inlet which is in communication with a high-pressure fuel source outside the injector body, having an actuator received in a hollow chamber from which hollow chamber a high-pressure inlet extends to an injection valve member, and as a function of the pressure in a first hydraulic chamber, fuel is injected into the combustion chamber of an internal combustion engine when the injection valve member lifts out of a seat, the improvement comprising a stepped piston acted directly on by the actuator, and a control piston in which the injection valve member is guided, the stepped piston defining the first hydraulic chamber and actuating the control piston.

14. The fuel injector as defined by claim 13, further comprising an annular face on the stepped piston defining the first hydraulic chamber, and a sleeve embracing the annular face.

15. The fuel injector as defined by claim 13, wherein the stepped piston is embodied with a first diameter and a second diameter, and wherein the first diameter exceeds the second diameter.

16. The fuel injector as defined by claim 13, wherein the control piston comprises both a second hydraulic chamber and a third hydraulic chamber which communicate hydraulically with one another, and wherein the control piston is guided in a guide of the injector body.

17. The fuel injector as defined by claim 13, further comprises a mechanical driver disposed on the injection valve member and guided in a hollow chamber of the control piston movably between a first and a second stroke stop.

18. The fuel injector as defined by claim 13, further comprising a spring element disposed between a face end of the control piston and the injection valve member, the spring biasing the injection valve member into a defined outset position relative to the control piston.

19. The fuel injector as defined by claim 15, wherein the control piston comprises both a second hydraulic chamber and a third hydraulic chamber which communicate hydraulically with one another, and wherein the control piston is guided in a guide of the injector body, and wherein upon subjection of the actuator to voltage, by simultaneous subjection of the first hydraulic chamber and the second hydraulic chamber to pressure via the stepped piston the injection valve member guided in the control piston is pressed into its seat.

20. The fuel injector as defined by claim 15, the control piston comprises both a second hydraulic chamber and a third hydraulic chamber which communicate hydraulically with one another, and wherein the control piston is guided in a guide of the injector body, and wherein upon termination of the subjection of the actuator to voltage, the first and second hydraulic chambers are simultaneously pressure-relieved and the third hydraulic chamber is pressure-relieved in delayed fashion, and wherein the control piston embraces a mechanical driver to move the injection valve member out of its seat.

21. The fuel injector as defined by claim 20, wherein the mechanical driver is disposed in a hollow chamber in the control piston, and wherein upon a delayed pressure relief of the third hydraulic chamber, the injection valve member automatically opens wider in accordance with the length of the hollow chamber.

22. The fuel injector as defined by claim 16, wherein the first hydraulic chamber and the second hydraulic chamber communicate with one another via a conduit containing a throttle restriction.

23. The fuel injector as defined by claim 14, further comprising a plane face embodied on the injector body, and wherein the sleeve surrounding the stepped piston is braced with a bite edge on the plane face.

24. The fuel injector as defined by claim 13, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

25. The fuel injector as defined by claim 14, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

26. The fuel injector as defined by claim 15, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

27. The fuel injector as defined by claim 16, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

28. The fuel injector as defined by claim 17, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

29. The fuel injector as defined by claim 18, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

30. The fuel injector as defined by claim 19, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

31. The fuel injector as defined by claim 20, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.

32. The fuel injector as defined by claim 21, wherein the opening of the injection valve member upon cancellation of the subjection of the actuator to voltage is effected by means of the pressure relief of the first hydraulic chamber, upon slaving of the injection valve member by the control piston, and by delayed pressure relief of the third hydraulic chamber in the control piston, while the injection valve member automatically moves in the opening direction relative to the control piston.
